(19) United States
(12) Patent Application Publication
(10) Pub. No.: US 2015/0323405 A1
(43) Pub. Date: Nov. 12, 2015

(54) A Method for Locally Resolved Pressure Measurement

(71) Applicant: FCT FIBER CABLE TECHNOLOGY GMBH, Gmünd (AT)

(72) Inventors: Rudolf Halmetschlager, Gmünd (AT); Petar Basic, Split (HR)

(21) Appl. No.: 14/647,446

(22) PCT Filed: Nov. 25, 2013
(86) PCT No.: PCT/EP2013/074627

§ 371 Date: May 26, 2015

(30) Foreign Application Priority Data
Nov. 27, 2012 (AT) A 1246/2012

(51) Int. Cl. G01L 11/02; E21B 47/06

(52) U.S. Cl. CPC G01L 11/025; E21B 47/06

(57) ABSTRACT

A method and an apparatus for the locally resolved pressure measurement along a pressure region (15), wherein it is proposed according to the invention that by using a glass optical fibre (11) comprising an optical fibre core (11″), an optical fibre cladding (11′), and an outer protective coating (16) and extending inside a tubular enclosure (6) in the longitudinal direction of the enclosure (6), a pressure acting isotropically on a length section of the tubular enclosure (6) arranged along the pressure region (15) is transformed into an asymmetric pressure load on the region of the optical fibre cladding (11′) situated within the length section, wherein the double refraction caused by the asymmetric pressure load in this length section is detected by using a reflection measurement along the optical fibre (11), and the pressure acting on the length section is determined from the asymmetric pressure load determined in this manner. The invention thus allows performing a locally resolved pressure measurement along the optical fibre (11) and determining the progression of pressure along the tubular enclosure (6) arranged in the pressure region (15) in a cost-effective manner.

The invention relates to a method for locally resolved pressure measurement along a pressure region according to the preamble of claim 1, and an apparatus for locally resolved pressure measurement along a pressure region according to the preamble of claim 2.

In many applications it is necessary to carry out pressure measurements under extreme conditions concerning the accessibility of the measuring range or the ambient temperature, e.g. in the gas and oil production industry, in the case of bearer cables such as in crane cable applications, in deep sea applications such as tsunami warning systems, or in high-pressure water conduits for power plants etc. In oil production for example it is necessary to know the pressure conditions in the borehole in order to enable the control and optimisation of the transport of the oil to the surface. Known methods especially provide electrical measuring devices for this purpose, which are installed within the pressure region in different depths and provide information on the pressure and the temperature. The use of such electrical measuring devices is very limited under adverse ambient conditions such as high temperature, strong vibrations, and high hydrostatic pressure, which is very problematic in practice. Furthermore, correct functionality must be ensured because erroneous pressure and temperature measurements can have fatal and expensive consequences, e.g. during the operation of a borehole. Furthermore, the transmission of electrical signals may be difficult when radio connections cannot be applied and electrical cables need to be laid with respective protection because adverse temperature and pressure conditions and the influence of corrosive liquids within the pressure region would rapidly damage the cable insulation.

That is why it was also proposed to carry out pressure and temperature measurements by means of optical methods, e.g. by means of optical interferometers, which are arranged at the end of a fibre-optic conductor and are introduced into the borehole. Optical interferometers are highly sensitive to changes in temperature during their measurements, so that different pressure values may be measured at the same pressure under varying temperatures. Furthermore, only one-off measurements are possible with optical interferometers. The determination of an approximately continuous pressure progression along the entire borehole depth is not possible with known measuring apparatuses.

It is therefore the object of the invention to realise a method for the locally resolved pressure measurement, which can especially also be used under measuring conditions such as a hydrostatic ambient pressure of up to 1000 bars or temperatures of several hundred degrees Celsius. It is a further object of the invention to provide a respective pressure measuring apparatus.

These objects are achieved by the features of claims 1 and 2. Claim 1 relates to a method for the locally resolved pressure measurement along a pressure region, in which it is provided in accordance with the invention that by using a glass optical fibre comprising an optical fibre core, an optical fibre cladding, and an outer protective coating and running inside a tubular enclosure in the longitudinal direction of the enclosure, pressure acting isotropically on a length section of the tubular enclosure arranged along the pressure region is transformed into an asymmetric pressure load on the region of the optical fibre cladding situated within the length section, wherein the double refraction caused by the asymmetric pressure load in this length section is detected by using a reflection measurement along the optical fibre, and the pressure acting on the length section is determined from the asymmetric pressure load determined in this manner.

The mathematical context between the outer pressure load on the tubular enclosure and the asymmetric load on the optical fibre cladding is obtained from the structural features of the arrangement of the optical fibres within the tubular enclosure and the structure of the glass fibres themselves, and is known for a specific arrangement. In other words, the optical fibre must be arranged within the tubular enclosure in a manner that said mathematical context is also known and determined. This context is also designated below as a kinematically defined coupling, i.e. that a predetermined isotropic pressure load on the tubular enclosure converts in a well-defined manner into a specific asymmetric pressure load on the optical fibre cladding. As a result, a pressure load on the tube cladding can be assigned to a specific, asymmetric loading case on the optical fibre cladding. Conversely, it is thus possible to also draw conclusions in an unequivocal manner from a measured, asymmetric loading case of the optical fibre cladding on the pressure applied from the outside on the tubular enclosure. Possibilities for constructional implementation of such a kinematically defined coupling will be explained below. In accordance with the invention, the measurement of the asymmetric pressure load on the optical fibre cladding within a length section occurs by means of a reflection measurement along the optical fibre, wherein the double refraction in this length section that is produced by the asymmetric pressure load is detected. One possibility for reflection measurement is the optical time domain reflectometry (OTDR), or the optical frequency domain reflectometry (OFRD) which is similar to OTDR, in which—in contrast to OTDR—operations are not performed in the time range, but in the frequency range. These respectively concern reflection measurements in which a laser light pulse is injected into the optical fibre and the (Rayleigh) backscatter light is measured over time. The measured signal has a time dependence which can be converted via the group velocity to local dependence. As a result, a locally resolved measurement can be realised. A special type of these reflection measurements is represented by the polarisation-optical time-domain reflectometry (POTDR). In this case, a polarizer is used at the input of the fibre, and an analyser arranged at a right angle thereto. The polarisation state of the backscattered light is recorded, from which it is possible to determine the beat length or the linear double refraction. This method allows determining local values of double refraction along the glass optical fibre. The local double refraction is dependent on quantities such as the external pressure and/or the temperature, and occurs in the reflection signal is a change in the ramp. The reflection signal per se can be supplied by means of an optical beam splitter to a detector which converts the optical signal into an electric signal for further evaluation. If the double refraction produced by the asymmetric pressure load is detected in a length section of the optical fibre, the isotropically acting pressure in this length section can be determined from the thus determined asymmetric pressure load via the kinematically defined coupling.

The invention thus provides using the optical fibre per se for the pressure measurements and performing measurements at many measuring points along the optical fibre, i.e. to perform a locally resolved pressure measurement along the optical fibre. Such a type of measurement allows determining a pressure progression along the glass fibre at low cost, i.e. the pressure progression within a borehole in which the optical fibre is arranged. The field of application of the measuring method in accordance with the invention is obviously not limited to boreholes, but is suitable for many areas of application in which pressure measurements need to be performed under adverse ambient conditions such as in pipelines or in other pressure-loaded devices.

Concerning the implementation of the method in accordance with the invention by means of apparatuses, an apparatus for the locally resolved pressure measurement along a pressure region is proposed in which it is provided in accordance with the invention that it is formed by an optical fibre comprising an optical fibre core, an optical fibre cladding, and an outer protective coating, whose optical fibre cladding and/or protective coating runs acentrically inside a tubular enclosure in the longitudinal direction of the enclosure, which tubular enclosure is isotropically pressure-loaded in the pressure region, wherein the optical fibre rests along a partial section of its circumferential region on the inside surface of the isotropically pressure-loaded enclosure, and two supporting fibres are provided which respectively rest along a partial section of their circumferential regions on the inside surface of the enclosure, and rest on or are integrally attached to the optical fibre along further partial sections of their circumferential regions, and rest on or are integrally attached to the respective other supporting fibre or a third supporting fibre along further partial sections of their circumferential regions. An isotropic pressure load is understood to be a pressure which is equally large in its scalar magnitude in the cross-sectional plane of the tubular enclosure along its circumference, i.e. a pressure which is independent of the direction. An isotropic pressure will mostly be provided under hydrostatic conditions, but it is relevant in accordance with the invention to subject the tubular enclosure to the pressure region directly, so that the isotropic pressure also acts directly on the tubular enclosure without being corrupted by enclosing or other structures.

The asymmetric loading case on the optical fibre cladding is achieved by an acentric arrangement of the optical fibre cladding and/or the protective coating of the optical fibre within the tubular enclosure. An acentric arrangement of the optical fibre cladding and/or the protective coating of the optical fibre mean in this respect that in a cross-section normally to the longitudinal axis of the tubular enclosure the centre point of the optical fibre cladding or the protective coating does not coincide with the centre point of the tubular enclosure. The longitudinal axes of the tubular enclosure and the optical fibre may extend in parallel with respect to each other, but not in the same axis. This arrangement must be seen in contrast to a coaxial arrangement of the optical fibre in relation to the tubular enclosure, in which in a cross-section normally to the longitudinal axis of the tubular enclosure the centre point of the optical fibre does coincide with the centre point of the tubular enclosure. The optical fibre cladding and the outer protective coating of the optical fibre can be concentric, so that an acentric arrangement of the optical fibre cladding is equivalent to an acentric arrangement of the protective coating. The optical fibre could also be produced in such a way that the optical fibre cladding does not extend concentrically within the protective coating, e.g. in that the cross-section of the protective coating is not arranged in the shape of a circular ring at all, but approximately in the shape of a triangle. In this case, the protective layer of the optical fibre can be arranged acentrically within the tubular enclosure, although the optical fibre cladding comes to lie centrically within the tubular enclosure. In this case too, an isotropic pressure load on the tubular enclosure can be converted into an asymmetric load on the optical fibre cladding.

If the optical fibre rests along a partial section of its circumferential region on the inside surface of the isotropically pressure-loaded enclosure, direct pressure transfer occurs from the enclosure to the optical fibre. In the case of such direct contact of the optical fibre on the inside surface of the enclosure, it is further proposed in accordance with the invention that two supporting fibres are provided which respectively rest along a partial section of their circumferential regions on the inside surface of the enclosure, respectively rest on or are integrally attached to the inside surface of the enclosure along a partial section of their circumferential regions, rest on or are integrally attached to the optical fibre along further partial sections of their circumferential regions, and either rest on the respectively other supporting fibre along further partial sections of their circumferential regions, or on a common third supporting fibre. If the optical fibres and the supporting fibres are formed with the same diameter, the centre points of the two supporting fibres and the optical fibre form in the first case an equilateral triangle in a cross-section, and a square in the second case when using a total of three supporting fibres in addition to the optical fibre, so that the asymmetric pressure load on the optical fibres can easily be calculated from the exterior isotropic pressure on the basis of simple geometric contexts. The optical fibre is manufactured with concentrically extending optical fibre core, optical fibre cladding and protective coating. Furthermore, a secure acentric fixing of the optical fibre within the enclosure is ensured, and thus a locally defined position of the optical fibre within a cross-sectional plane of the tubular enclosure. The tubular enclosure concerns a rigid, preferably metallic, small tube, e.g. a small stainless steel tube.

It can be provided concerning the optical fibre core that the optical fibre core coils within the optical fibre cladding at least in sections along a helical line around the longitudinal axis of the optical fibre. As will be explained below in closer detail, the temperature-dependence of the measurement can be reduced by means of such an arrangement and the measuring precision can thus be increased.

At least one of the supporting fibres preferably concerns a further optical fibre, which can be arranged as a multimode fibre or as a single-mode fibre and can be used for example for the locally resolved temperature measurement. Locally resolved temperature measurements by means of optical fibres are known and can be used within the scope of the invention for increasing the precision of the pressure measurement. High temperatures can cause thermal expansion of the involved components for example, which can have an effect on the pressure measurement in accordance with the invention, especially in such embodiments in which the optical fibre and/or at least one supporting fibre rest directly on the inside surface of the tubular enclosure. That is why it is advantageous to provide locally resolved temperature information for the calibration of the pressure measurement.

It is further proposed that the tubular enclosure concerns a cylindrical symmetric enclosure. The enclosure, which is arranged in a cylindrical symmetric way in its outer circumference, is especially advantageous for applications under high ambient pressure, because in the case of an asymmetric configuration the outer loads would lead to deformations and finally destruction of the enclosure. The asymmetric loading case on the optical fibre can also be achieved by a coaxial arrangement within a tubular enclosure if the tubular enclosure has an elliptical cross-section. In this case, an optical fibre could be provided which rests with an elliptical cross-section on the inside surface of a tubular enclosure, so that it is loaded asymmetrically despite an isotropic pressure load on the tubular enclosure.

The invention will be explained below in closer detail by reference to embodiments shown in the enclosed drawings, wherein:

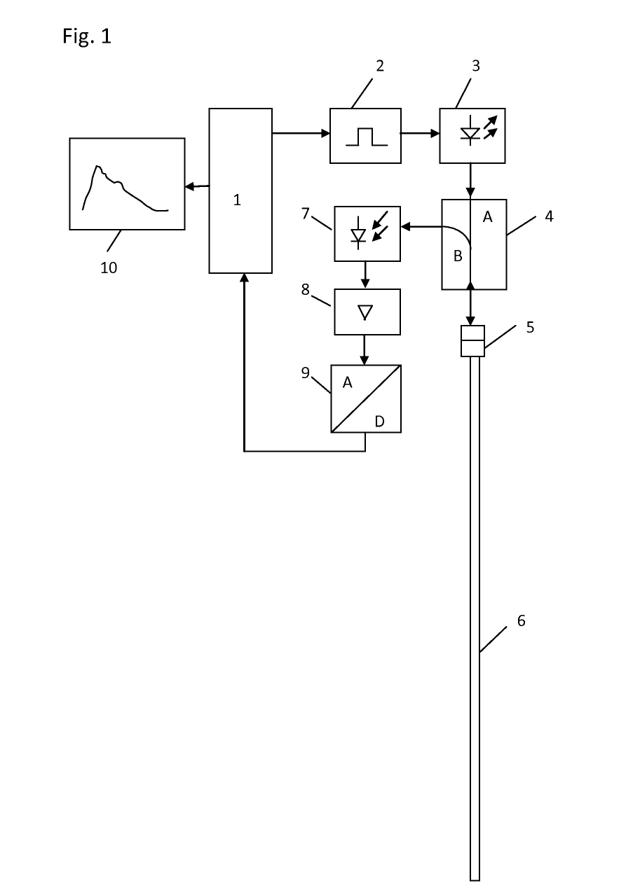

FIG. 1 shows a schematic view of a measuring arrangement for performing the method in accordance with the invention and for using the apparatus in accordance with the invention;

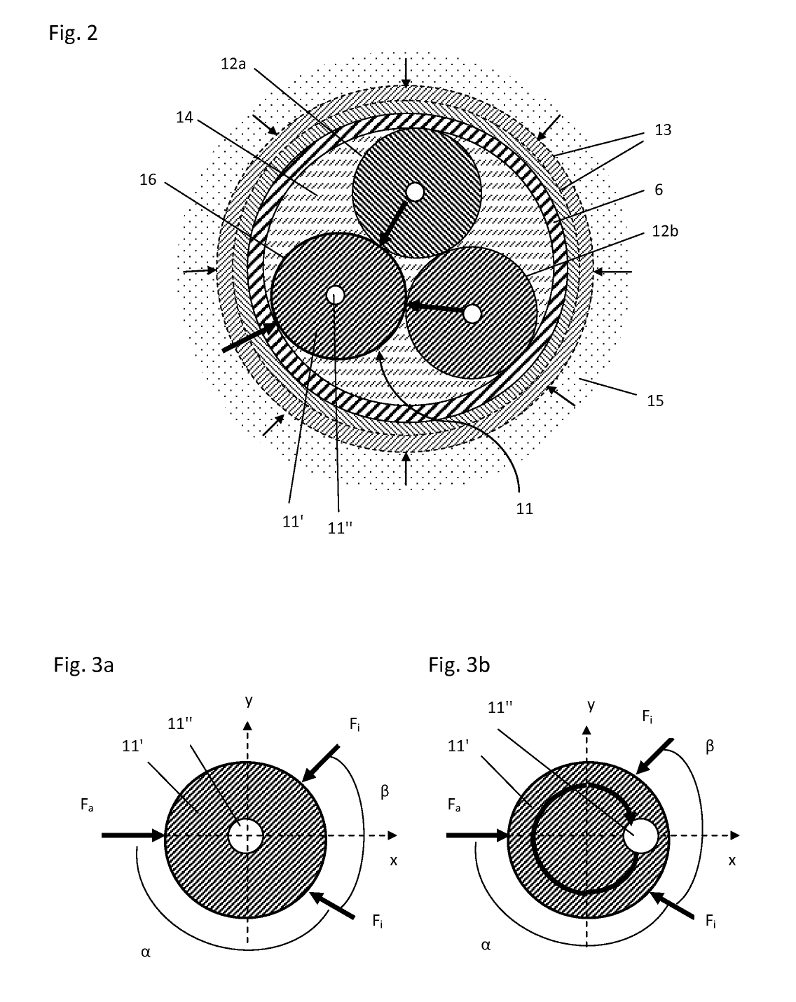

FIG. 2 shows a schematic view of a first embodiment of an apparatus in accordance with the invention for the locally resolved pressure measurement, in which an optical fibre and two supporting fibres arranged as optical fibres are arranged within a tubular enclosure in contact with the inside surface of said enclosure;

FIG. 3a shows a schematic view of the pressure conditions on an optical fibre in an arrangement according to FIG. 2;

FIG. 3b shows a schematic view of the pressure conditions on an optical fibre in an arrangement according to FIG. 2, but with an optical fibre core which is wound in a helical manner around the longitudinal axis;

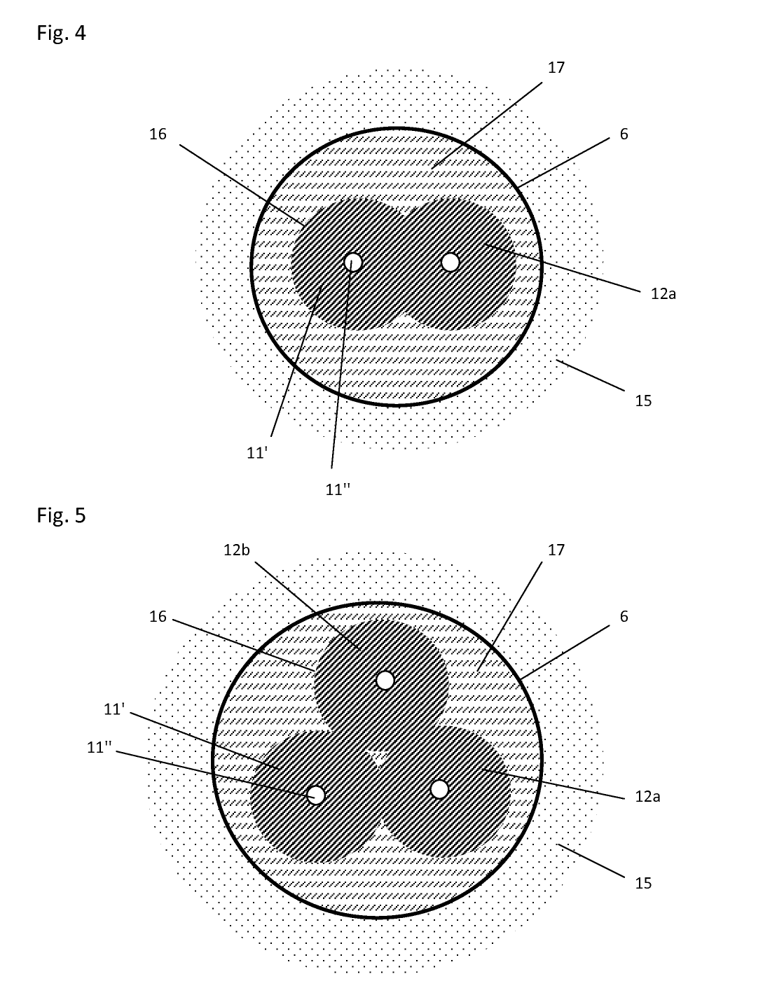

FIG. 4 shows a schematic view of a further embodiment of an apparatus for the locally resolved pressure measurement, in which two optical fibres are integrally formed on each other and are arranged within a tubular enclosure;

FIG. 5 shows a schematic view of a further embodiment of an apparatus for the locally resolved pressure measurement, in which three optical fibres are integrally formed on each other and are arranged within a tubular enclosure;

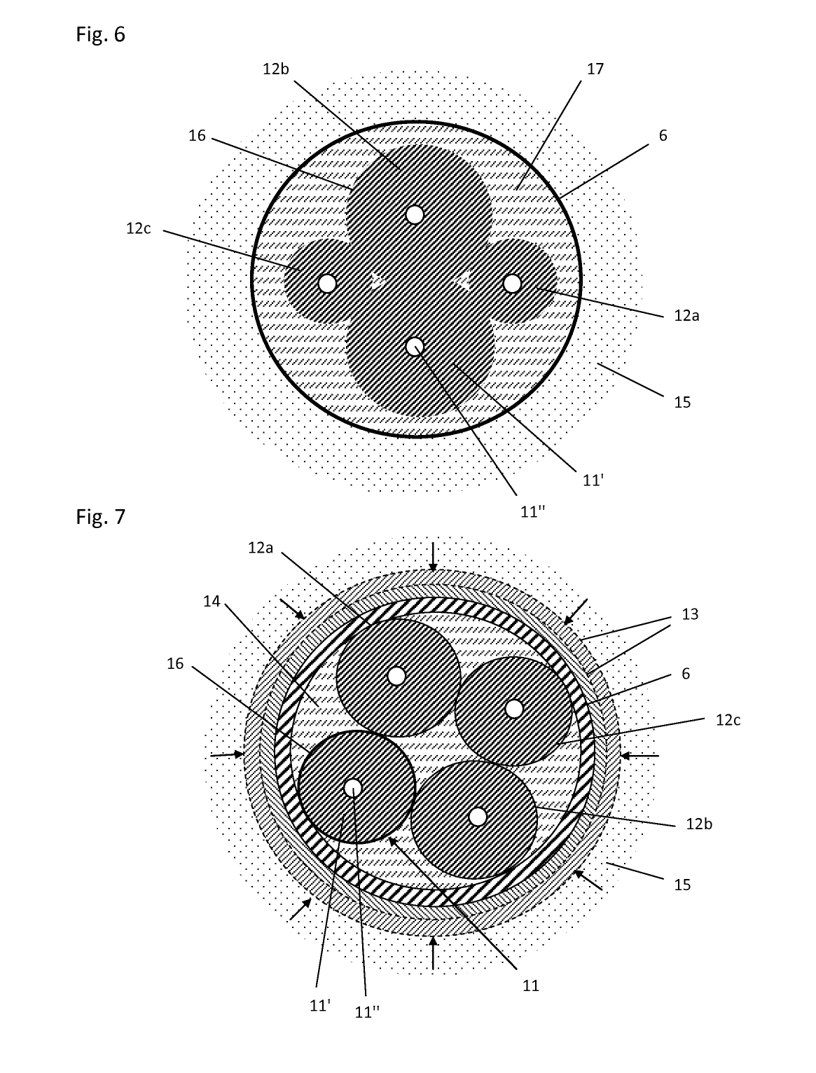

FIG. 6 shows a schematic view of a further embodiment of an apparatus for the locally resolved pressure measurement, in which four optical fibres are integrally formed on each other and are arranged within a tubular enclosure, and

FIG. 7 shows a schematic view of a further embodiment of an apparatus in accordance with the invention for the locally resolved pressure measurement, in which an optical fibre and three supporting fibres arranged as optical fibres are arranged within a tubular enclosure in contact with its inside surface.

Reference is made at first to FIG. 1 in order to explain the general configuration concerning the measuring equipment for performing the method in accordance with the invention and for applying the apparatus in accordance with the invention. A pulse generator 2 is triggered via a data-processing device 1, which pulse generator generates light pulses by means of a laser diode 3. Said laser light pulses are injected by an optical beam splitter 4 along the path “A” via a connector 5 into the optical fibre 11 (see FIG. 2), which is arranged within a tubular enclosure 6, as will be explained below in closer detail. The backscattered light is supplied by the optical beam splitter 4 along the path “B” to a photodetector 7, which converts the optical reflection signal into an electrical signal. The electrical signal can be amplified by means of an amplifier 8 and converted by means of an analogue-to-digital converter 9 into a digital signal. The digital reflection signal is finally supplied to an output unit 10 via a data-processing device 1. The described configuration can also vary, but is otherwise generally known. A method and an apparatus for the locally resolved pressure measurement is proposed for application on generally known reflection measurements under measuring conditions such as an ambient pressure of up to 1000 bars or temperatures of several hundred degrees Celsius, as will be described below by reference to the enclosed drawings.

FIG. 2 shows a schematic view of a first embodiment of an apparatus in accordance with the invention for the locally resolved pressure measurement, in which an optical fibre 11 is arranged within a tubular enclosure 6, and two supporting fibres 12a, 12b which respectively rest along a partial section of their circumferential regions on the inside surface of the enclosure 6 and along further partial sections of their circumferential regions on the respective other supporting fibres 12a, 12b and the optical fibre 11. The free space 14 between the tubular enclosure 6 and the optical fibre 11 as well as the supporting fibres 12a, 12b can be filled with a protective gas or a gel. A filling material is not absolutely necessary in this embodiment because the kinematically defined coupling via direct contact of the optical fibre 11 and the supporting fibres 12a, 12b on the enclosure 6 is provided securely. The free space 14 can thus also be evacuated. The cylindrically symmetric tubular enclosure 6 is inelastic and produced as a tight small stainless steel tube and can be surrounded by further tubular enclosure layers 13 which allow scalability of the pressure measurement. The optical fibre 11 can be produced with an exterior diameter of its optical fibre cladding 11′ ranging from a few micrometers up to a few hundred micrometers. As a result of current production limits for the metallic tubular enclosure 6, the optical fibre 11 has exterior diameter in the range of a few hundred micrometers, and the tubular enclosure has an inside diameter which corresponds approximately to twice to three times the outside diameter of the optical fibre 11, i.e. approximately in the range of 1 mm. The apparatus in accordance with the invention is subjected according to FIG. 2 to a pressure region 15, as occurs within an oil well for example. A high hydrostatic pressure may thus act on the outer circumference of the tubular enclosure 6, which hydrostatic pressure is represented as an isotropic pressure as a result of the small outside diameter of the tubular enclosure 6 and its cylindrical symmetry, as is indicated in FIG. 2 by the small, radially extending arrows, i.e. as a radially acting pressure which has the same scalable value along the outer circumference of the enclosure 6. The isotropy of the applied pressure, i.e. a pressure which is symmetric in its scalable magnitude along the circumferential region of the tubular enclosure, can be achieved the better the smaller the outer diameter of the tubular enclosure is arranged, e.g. less than 1.5 mm, preferably less than 0.5 mm.

The optical fibre 11 comprises an optical fibre cladding 11′ and an optical fibre core 11″. Furthermore, it will be provided with an outer protective coating 16, whose thickness and material can vary. Protective coatings 16 made of carbon or a metallic material are known, which are predominantly used within the scope of the invention in the high-temperature range. Polymeric materials such as acrylates can also be used for the protective coating 16 at lower temperatures, or polyimides as a material of higher quality. In the present application, the term “optical fibre” is understood in such a way that there are an optical fibre cladding 11′, an optical fibre core 11″, and a protective coating 16 made of varying material and thickness, but no further coatings as are known as a “jacket” for example. Especially the use of conventional synthetic materials should be avoided when using the apparatus in accordance with the invention at high temperatures. The optical fibre cladding 11′ and the optical fibre core 11″ conduct light by means of the known principles of total reflection, wherein their configuration and composition are generally known. The optical fibre cladding 11′ and the optical fibre core 11″ preferably form a sudden transition in the respective refractive index. So-called single mode (SM) fibres are usually used for reflection measurements. In a single mode (SM) fibre, two orthogonal HE₁₁ modes are capable of propagation. Their direction of polarisation can be selected arbitrarily in the X and Y direction (HE₁₁ₓ,HE_{11y}). These two modes represent the eigenmodes of the polarisation of an SM fibre. The electric field vector of a wave propagating in the Z direction (normally to the plane of the sheet in FIG. 2) can thus be represented in a lossless assumed SM fibre as a linear superposition of these two modes. Each mode can further be associated with an effective refractive index and a propagation constant, which in addition to the effective refractive index also depends on the (free space) wavelength of the injected light. Both quantities are equally large for both modes in ideal SM fibres, i.e. in unbent fibres of perfectly circular cross-section and free from mechanical tensions. This is mostly not the case in real fibres. Instead, a difference occurs in the propagation constants of the two modes, which is also known as linear double refraction of the optical fibre 11. Such a double refraction in an optical fibre 11 always occurs when anisotropy of the refractive index occurs in the optical fibre core 11″. Said anisotropy is caused by a disturbance in the ideal circular symmetry as a result of geometric deformations, mechanical tensions or external electrical or magnetic fields. An elliptical cross-sectional shape leads to a linear double refraction for example, wherein polarised light propagates quickest parallel to the minor axis of said ellipse. Mechanical loads can also cause an elastic-optical change in the refractive index in the optical fibre 11 and thus linear double refraction. If an asymmetric distribution of forces is acting, anisotropy occurs in the distribution of the refractive index. Such loads can also be caused by external effects such as pressure or tensile forces, as will be explained by reference to FIG. 3.

FIG. 3 shows in an enlarged illustration the correlation of forces acting on the optical fibre cladding 11′ in a configuration according to FIG. 2. The external force on the enclosure 6 is illustrated in a force Fₐ which in FIGS. 3a and 3b respectively acts from the left along the X axis. Furthermore, the forces Fᵢ are exerted on the optical fibre cladding 11′ by the two supporting fibres 12a, 12b, which forces respectively comprise an X and Y component. The angle α between the force Fₐ and the force Fᵢ is greater than the angle β between the forces Fᵢ (the angle α is 150° and the angle β is 60°). The geometrical analysis shows that although the sum total of the forces disappears in the Y direction, the sum total of the forces in the X direction does not, so that an asymmetric load acts on the optical fibre cladding 11′. The deformation of the optical fibre cladding 11′ and the optical fibre core 11″ caused by said asymmetric load locally produces a double refraction which can be measured. Since the geometrical conditions are well-known, it is possible with known double refraction to draw conclusions on the distribution of forces of Fₐ and Fᵢ, and subsequently to the applied external pressure. Since the locally existing double refraction can be measured in a locally resolved manner, the applied pressure can also be determined in a locally resolved manner.

The two supporting fibres 12a, 12b can be formed as multimode fibres or single mode fibres in order to carry out locally resolved temperature measurements for example, which can be used for a correction of the locally measured pressure. High temperatures can cause thermal expansion of the enclosure 6, the optical fibre 11, the supporting fibres 12a, 12b, and a potential filling material in the free space 14, which can have an effect on the pressure measurement in accordance with the invention. That is why it is advantageous to provide locally resolved temperature information for the calibration of the pressure measurement. One of the two supporting fibres 12a, 12b could further also be used for additional measurements of tensile and pressure loads. The primary function of the two supporting fibres 12a, 12b is to ensure secure, acentric fixing of the optical fibre 11 within the enclosure 6 and thus a locally defined position of the optical fibre 11 within a cross-sectional plane of the tubular enclosure 6.

The precision of the locally resolved pressure measurement can also be improved in that a configuration according to FIG. 3b is selected. FIG. 3b shows an optical fibre 11 with an optical fibre core 11″, which coils within the optical fibre cladding 11′ along a helical line around the longitudinal axis of the optical fibre 11, i.e. it is not arranged coaxially to the optical fibre cladding 11′. The helical line appears as a circular line in a projection in the direction of the longitudinal axis of the optical fibre 11, as indicated in FIG. 3b, which circular line is shown in FIG. 3b as a circular arrow. When external forces occur, different values of the double refraction are obtained along a winding of the helical line in the optical fibre core 11″, which values are repeated in each winding as a result of the axial symmetry of the arrangement. A laser light pulse which propagates through the optical fibre core 11″ which is coiled in the manner of a helical line is thus subjected to double refraction which varies periodically along a winding about the longitudinal axis of the optical fibre 11. As a result, the reflection signal also varies periodically between maxima and minima. If the reflection signal is now only evaluated at the maxima or minima, high independence of variations can be achieved as a result of temperature changes because the changes in temperature substantially only shift the position of the maxima and minima but do not change their absolute height. If the optical fibre core 11″ according to FIG. 3a is arranged coaxially to the optical fibre cladding 11′, i.e. parallel to the longitudinal axis of the optical fibre 11 and centrically in relation to the optical fibre cladding 11′, the absolute position of the optical fibre core relative to the optical axis (designated as X axis in FIG. 3a) can vary in a temperature-dependent manner, so that the measured values of the double refraction also show temperature-dependent imprecision. In the case of a helical arrangement of the optical fibre core 11″ in the optical fibre cladding 11′ according to FIG. 3b, the absolute position of the optical fibre core 11″ relative to the optical axis is no longer relevant because the measurement of the double refraction always occurs at the maximum or minimum. The ascending gradient of the helical line which is followed by the optical fibre core 11″ is preferably selected in such a way that for the duration of a laser light pulse laser light passes through a plurality of windings of the optical fibre core 11″ around the longitudinal axis of the optical fibre 11.

Concerning the protective coating 16, a very thin configuration of the protective coating 16 could be considered if the tubular enclosure 6 can be produced with respectively small diameters. It would also be possible to form the protective coating 16 in a respectively thicker way in order to allow increasing the diameter of the tubular enclosure 6 and to thus facilitate its production. In this process, a polymer material is preferable for the protective coating 16 if the tubular enclosure is made of a metallic material so as to reduce the requirements placed on production tolerances.

Within the terms of the aforementioned embodiment, a single optical fibre 11 could also be provided whose protective coating 16 is made in such a way that it comprises a triangular cross-section. The triangular cross-section would be selected in such a way that an acentric position is obtained either in the optical fibre cladding 11′ and/or the protective coating 16 within the tubular enclosure, i.e. in the form of an equilateral triangle which is centrically arranged within the tubular enclosure 6, wherein the optical fibre cladding 11′ (and thus the optical fibre core 11″) are arranged acentrically relative to the protective coating 16, or in the form of an equilateral triangle which is acentrically arranged within the tubular enclosure 6, wherein the optical fibre cladding 11′ (and thus the optical fibre core 11″) is centrically arranged relative to the protective coating 16. The optical fibre 11 rests on the inside surface of the isotropically pressure-loaded enclosure 6 along a partial section of its circumferential region, namely in the corner regions of the triangular protective coating 16.

An alternative embodiment for realising the method in accordance with the invention is described by reference to FIGS. 4 to 6, in which there is no direct contact of the optical fibre 11 on the inside surface of the tubular enclosure 6. Production tolerances are less relevant in such embodiments. Furthermore, a lower temperature dependence of the pressure measurement can be recognised. In this case, at least one supporting fibre 12 is provided, which is integrally formed on the optical fibre 11, wherein the at least one supporting fibre 12 and the optical fibre 11 are embedded in a transverse isotropically pressure-conducting medium 11, e.g. a high-temperature-resistant synthetic material, a gel or a polymer material such as acrylate. The optical fibre 11 and the at least one supporting fibre 12 are provided with a protective coating 16, made of carbon or a metallic material for example. The tubular enclosure 6 is made of copper or steel for example. A supporting fibre 12a is provided in FIG. 4; it is also possible to use configurations with two supporting fibre is 12a, 12b (see FIG. 5) or three porting fibres 12a, 12b, 12c (see FIG. 6), wherein the diameters of the optical fibres 11 and the supporting fibres 12 can also be chosen differently. In the illustrated configurations, an isotropic hydrostatic pressure is converted in a well-defined manner into an asymmetric distribution of forces on the optical fibre cladding 11′. It is possible in this case to reduce the size of the arrangement in such a way that the outside diameter of the tubular enclosure is only in the range of a few hundred micrometers. The integral formation of the at least one supporting fibre 12 on the optical fibre 11 represents a defined arrangement of the optical fibre 11 relative to the at least one supporting fibre 12 and the resulting asymmetric loading case on the optical fibre cladding 11′.

The tubular enclosure 6 can comprise openings, wherein in this case no transverse isotropically pressure-conducting medium 17 is provided. Instead, an external fluid, i.e. a gas or a liquid, penetrates the interior of the tubular enclosure 6 from the pressure region 15 and acts directly on the optical fibre 11. The protective coating 16 must be made of a high-temperature-resistant material especially in this case.

The supporting fibres 12a, 12b, 12c can be arranged as multimode fibres or single mode fibres in order to perform compensation measurements with respect to the temperature or pressure and tensile forces. Furthermore, the respective core and the cladding of the optical fibres 11 and the supporting fibres 12 can be arranged with different geometries or different materials in order to enable precise adjustments to the pressure sensitivity.

In the illustrated examples according to FIGS. 4 to 6, the optical fibres 11 and the supporting fibres 12 can be manufactured with an exterior diameter in the magnitude of approximately 100 micrometers, and the tubular enclosure 6 with an internal diameter of approximately 2 to 3 times the (maximum) outside diameter of the optical fibre 11 and the supporting fibres 12, i.e. approximately in the magnitude of 300 micrometers.

FIG. 7 shows a schematic view of a further embodiment of an apparatus in accordance with the invention for the locally resolved pressure measurement, in which three supporting fibres 12a, 12b, 12c are also used, but with a configuration comparable to FIG. 2. In this case too, an optical fibre 11 comprising an optical fibre core 11″, an optical fibre cladding 11′, and an exterior protective coating 16 is arranged within the rigidly formed tubular enclosure 6 in such a way that its optical fibre cladding 11′ and/or its protective coating 16 extends acentrically in the longitudinal direction of the tubular enclosure 6 which is isotropically pressure-loaded in the pressure region 15. The optical fibre 11 rests on the inside surface of the isotropically pressure-loaded enclosure 6 along a partial section of its circumferential region. Furthermore, two supporting fibres 12a, 12b are provided, which respectively rest on the inside surface of the enclosure 6 along a partial section of their circumferential regions, on the optical fibre 11 along further partial sections of their circumferential regions, and on a third supporting fibre 12c along further partial sections of their circumferential regions. In the illustrated embodiment, the three supporting fibres 12a, 12b, 12c are respectively arranged as optical fibres. The primary function of the three supporting fibres 12a, 12b, 12c is to ensure a secure acentric fixing of the optical fibres 11 within the enclosure 6 and thus a locally defined position of the optical fibres 11 within a cross-sectional plane of the tubular enclosure 6. A kinematically defined coupling can thus be achieved, so that a predetermined isotropic pressure load on the tubular enclosure 6 is converted in a well-defined manner into a specific asymmetric pressure load on the optical fibre cladding 11′.

The invention thus allows performing pressure measurements at many measuring points along the optical fibre 11, i.e. to thus perform a locally resolved pressure measurement along the optical fibre 11. Such a type of measurement allows determining in a cost-effective manner the pressure progression along the tubular enclosure 6 arranged in the pressure region 15, i.e. the pressure progression within a borehole in which the optical fibre 11 is arranged with its tubular enclosure 6, which also especially includes measuring conditions with a hydrostatic ambient pressure of up to 1000 bars or temperatures of several hundred degrees Celsius. It is obvious that the field of application of the apparatus in accordance with the invention is not limited to boreholes, but it is suitable for many fields of application in which pressure measurements need to be performed under adverse ambient conditions, e.g. in pipelines or in other pressure-loaded installations.

1-5. (canceled)

6. An apparatus for the locally resolved pressure measurement along a pressure region (15), characterized in that it is formed from an optical fibre (11) comprising an optical fibre core (11″), an optical fibre cladding (11′), and an outer protective coating (16), whose optical fibre cladding (11′) and/or protective coating (16) runs acentrically inside a tubular enclosure (6) in the longitudinal direction of the enclosure (6), which tubular enclosure (6) is isotropically pressure-loaded in the pressure region (15), wherein the optical fibre (11) rests along a partial section of its circumferential region on the inside surface of the isotropically pressure-loaded enclosure (6), and two supporting fibres (12a, 12b) are provided which respectively rest along a partial section of their circumferential regions on the inside surface of the enclosure (6), and rest on or are integrally attached to the optical fibre (11) along further partial sections of their circumferential regions, and rest on or are integrally attached to the respective other supporting fibre (12a, 12b) or a third supporting fibre (12c) along further partial sections of their circumferential regions.

7. The apparatus for the locally resolved pressure measurement according to claim 6, characterized in that the optical fibre core (11″) coils within the optical fibre cladding (11′) at least in sections along a helical line around the longitudinal axis of the optical fibre (11).

8. The apparatus for the locally resolved pressure measurement according to claim 6, characterized in that at least one of the supporting fibres (12a, 12b, 12c) concerns a further optical fibre.

9. The apparatus for the locally resolved pressure measurement according to claim 6, characterized in that the tubular enclosure (6) concerns a cylindrical symmetric enclosure (6).
